(19) United States
(12) Patent Application Publication
(10) Pub. No.: US 2022/0335288 A1
(43) Pub. Date: Oct. 20, 2022

(54) SYSTEMS, APPARATUSES AND METHODS FOR DETECTING AND CLASSIFYING PATTERNS OF HEATMAPS

(71) Applicant: MICRON TECHNOLOGY, INC., BOISE, ID (US)

(72) Inventors: Marta Egorova, Boise, ID (US); Justin F. Zimmerman, Boise, ID (US)

(73) Assignee: MICRON TECHNOLOGY, INC., BOISE, ID (US)

(21) Appl. No.: 17/301,865

(22) Filed: Apr. 16, 2021

(51) Int. Cl. G06N 3/08; G06N 3/04; G06T 7/00

(52) U.S. Cl. CPC G06N 3/08; G06N 3/0454; G06T 7/001; G06T 2207/20081; G06T 2207/20084; G06T 2207/30148

(57) ABSTRACT

Methods, systems, and apparatuses related to identifying defects in a manufactured product using image recognition are described. Non-imaging data may be converted into an image by encoding the data to a heatmap. The resulting heatmap may be analyzed by one or more artificial intelligence model using image analysis techniques to provide an inference. The inference may indicate a pattern and/or a classification of a pattern of the heatmap.

### BACKGROUND

In manufacturing and production applications, various materials and products may be examined to detect defects. Some or all of the raw material, partially processed material, product, or the like may be unusable due to defects. Accordingly, it may be important to identify such defects in the wafer to control use and/or distribution of defective products.

### BRIEF DESCRIPTION OF THE DRAWINGS

FIG. 1 is an example heatmap according to at least one embodiment of the present disclosure.

FIG. 2 is an example heatmap of a semiconductor wafer according to at least one embodiment of the present disclosure.

FIG. 3 is a diagram illustrating an overview of data flow according to at least one embodiment of the present disclosure.

FIG. 4 shows example heatmaps of semiconductor wafers according to at least one embodiment of the present disclosure.

FIG. 5 is a flowchart providing an overview of methods according to at least one embodiment of the present disclosure.

FIG. 6 is an illustration of an example application of output data according to at least one embodiment of the present disclosure.

FIG. 7 is an example of multiple heatmaps generated from a same data set according to at least one embodiment of the disclosure.

FIG. 8 is an example of multiple heatmaps generated from different data sets for same physical locations according to at least one embodiment of the disclosure.

FIG. 9 is a block diagram of a model for analyzing data according to at least one embodiment of the disclosure.

FIG. 10 is a block diagram of a model for analyzing data according to at least one embodiment of the disclosure.

FIG. 11 is a schematic illustration of a computing system arranged according to at least one embodiment of the present disclosure.

FIG. 12 is a flow chart of a method according to at least one embodiment of the present disclosure.

FIG. 13 is a flow chart of a method according to at least one embodiment of the present disclosure.

### DETAILED DESCRIPTION

According to embodiments of the present disclosure, one or more types of data may be encoded into a “heatmap” to generate an image, which may be used to identify defects in a manufacturing or design process. One or more artificial intelligence (AI) techniques may be used to analyze the image to provide an inference. The inference may include identification and/or classification of a pattern (e.g., anomaly, defect). For example, testing data from die on a wafer may be encoded into a heatmap where individual pixels of the heatmap represent corresponding die of the wafer. The heatmap may be analyzed by AI to detect and/or classify defects on the wafer. In some examples, the output of the AI may be used to grade individual die and/or select die. In some examples, the AI may be used to generate a pixel mask to indicate the grade of the die and/or die to be selected.

As used herein, AI is used to refer to methods and techniques that enable a computing system to perform one or more tasks. AI may include, but is not limited to, machine learning models such as convolutional neural networks, recurrent neural networks, and support vector machines. An AI model may be trained to make inferences (e.g., predictions, classifications) based on input data. The inferences may be provided as output data. In some applications, the AI model may further provide a confidence level (e.g., score) indicating a probability that the inference is correct.

Significant advances have been made in AI for extracting information from images. For example, AI has been used to analyze optical images (e.g., images acquired by a digital camera) to detect and/or classify objects, such as for guiding autonomous vehicles on city streets. AI has also been used to analyze non-optical images such as ultrasound and magnetic resonance images of anatomical structures to detect and/or classify lesions.

Manufacturing processes have also taken advantages of the advances in AI for image analysis. For example, optical images of semiconductor wafers are acquired at various points during the fabrication process. The images are analyzed by various AI models to detect and/or classify defects in the wafers. AI may permit hundreds or thousands of wafer images to be analyzed in a fraction of the time it would take for a human. In some applications, the AI may more accurately and/or more consistently detect and/or classify defects in the wafers from the images. Semiconductor manufacturers typically perform multiple quality control tests on the wafers. However, these tests may not provide data in the form of an image (e.g., impedance measurements, computation speed). This data may not benefit from the advances in AI in the field of image analysis (e.g., computer vision), which may limit the inferences that can be made from the data.

According to embodiments of the present disclosure, data (e.g., a data set), which may include multiple data points, that is not typically associated with an image (e.g., numerical data) may be encoded as a “heatmap.” The heatmap may be generated by assigning a pixel having an intensity and/or hue (e.g., color) for each data point based on a value of the data point. In some embodiments, the location of the pixel in the heatmap may be based, at least in part, on a physical location, for example, where the data was acquired (e.g., measured). Many of the examples described in this description relate to semiconductor manufacturing. But the problems discussed and the solutions described apply to any manufacturing or design process that involves heatmap generation and analysis to identify or infer defects in manufacturing processes and manufactured products.

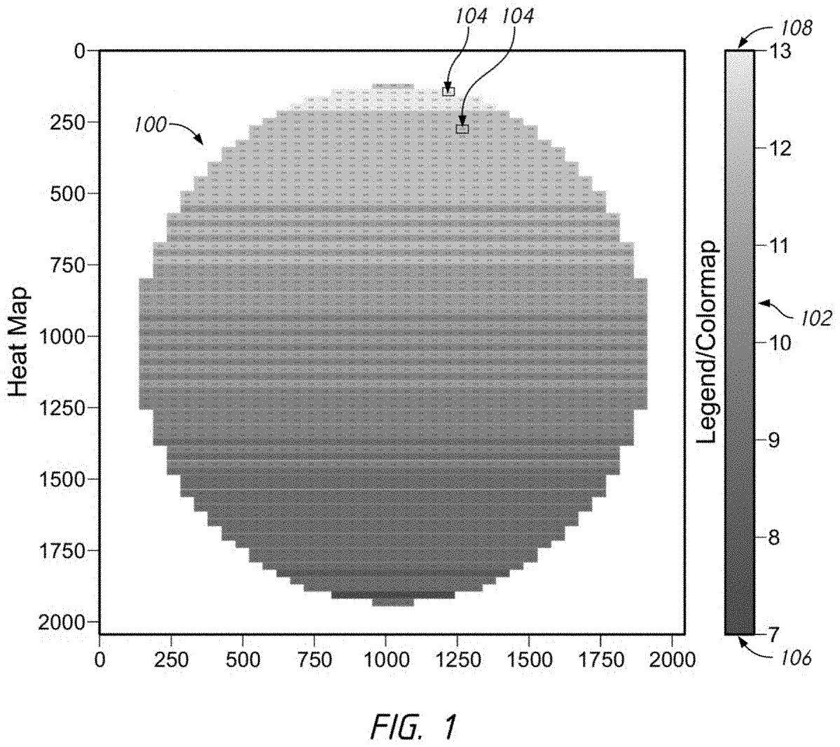

FIG. 1 is an example heatmap according to at least one embodiment of the present disclosure. The example shown in FIG. 1 is a heatmap 100 of a semiconductor wafer including multiple die. In some embodiments, individual die may include a memory device, such as a dynamic random access memory (DRAM). Pixels 104 of the heatmap 100 may correspond to die on the wafer. The color, intensity, and/or other property of a pixel 104 may be based, at least in part, on a value of data acquired from the corresponding die. Example data include, but are not limited to, impedance, voltage, current, operation speed, temperature, and number of failed elements on the die. The values of the data points may be mapped to different colors and/or intensities as shown in the legend/colormap 102. In some embodiments, each value may be mapped to a different color and/or intensity (e.g., 1=red, 2=orange, 3=yellow, etc.). In some embodiments, ranges of values may be mapped to different colors and/or intensities (e.g., 0-0.5=red, 0.6-1=orange, etc.).

In some embodiments, the range of colors and/or intensities may be set such that the minimum value of the data is represented by the minimum value of the color and/or intensity 106 and the maximum value of the data is represented by the maximum value of the color and/or intensity 108. In other embodiments, one or more threshold (e.g., cutoff) values may be assigned to the data. The color and/or intensity assigned to a pixel may be based on a comparison of the value to the threshold. For example, if values of the data range from 0-100, a threshold value may be assigned such that any value equal to or greater than 80 is represented by the maximum value of the color and/or intensity 108. Thus, all data points having values equal to or greater than 80 are represented by the same color in the heatmap. In another example, if the values of the data range from 0-100, a threshold value may be assigned such that any value equal to or less than 20 are represented by the minimum value of the color and/or intensity 106. In some embodiments, both minimum and maximum threshold values may be applied when generating the heatmap. In some applications, threshold values may be assigned based on acceptable values for the measurements. For example, when the data includes operational speed measurements, if die operating below 1500 MHz are unacceptable, a threshold value may be set such that all pixels corresponding to die with operational speed measurements below 1500 MHz are represented by the minimum value of the color and/or intensity 106.

In some embodiments, encoding data as a heatmap may allow “non-image” data (e.g., repair data, current measurements) to be organized as an image. This may be useful in some applications, such as when data is associated with one or more physical locations. When non-image data associated with physical locations is provided as a heatmap, patterns (e.g., defects) and/or additional information may be derived from the data. In some instances, the patterns and/or additional information may not have been as apparent or detectable when the data is provided in its original form (e.g., non-image).

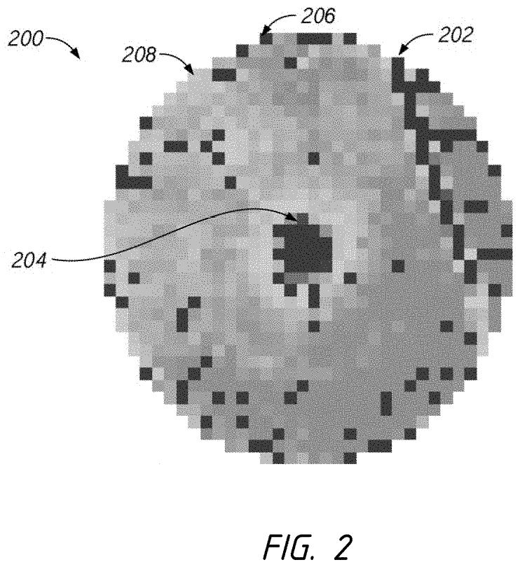

FIG. 2 is an example heatmap of a semiconductor wafer according to at least one embodiment of the present disclosure. The heatmap 200 was generated based on repair measurements acquired from individual die on the semiconductor wafer. Individual pixels of the heatmap 200 may correspond to individual die on the semiconductor wafer. In the example heatmap 200, darker pixels (e.g., pixel 206) correspond to die with higher repair counts (e.g., replacing word lines with redundant word lines) and lighter pixels (e.g., pixel 208) correspond to die with lower repair counts. Although reference is made to lighter and darker pixels, in other embodiments, different colors may be associated with high repair counts (e.g., red) and low repair counts (e.g., blue). Heatmap 200 includes a line 202 of die that have high repair counts in the upper right-hand side of the wafer and a cluster 204 of die that have high repair counts in the center of the wafer. These spatial patterns (e.g., line 202 and cluster 204) may be indicative of defects not only in individual die, but in the wafer. For example, line 202 may be indicative of a scratch on the wafer and cluster 204 may be indicative of an uneven doping of the wafer. In some instances, flaws in the wafer may indicate an issue in a process and/or equipment. Some flaws, such as uneven doping, may not be readily apparent from an optical image of the wafer and/or by reviewing the raw repair count measurements of the die. Accordingly, providing the data as heatmap 200 may allow additional detection of manufacturing flaws.

While the example shown in FIG. 2 illustrates that at least some defects may be detected by human observation of the heatmap, properly detecting patterns, such as defects, from heatmaps may require time and skill. For manufacturing applications, such as semiconductor fabrication, hundreds or thousands of products may be produced every day and tested multiple times during fabrication, further increasing the number of heatmaps that require examination. Thus, it may become impracticable for humans to examine the heatmaps.

According to embodiments of the present disclosure, AI models may be trained to analyze the heatmaps to detect and/or classify patterns in the heatmaps. For example, the patterns may correspond to flaws in a semiconductor wafer. In some embodiments, the AI models may be based, at least in part, on AI models typically used for image analysis (e.g., facial recognition, object recognition, medical diagnosis). In some applications, the AI models for image analysis may provide better performance analyzing the heatmaps than other non-image analysis AI models for analyzing the raw data (e.g., non-heatmap). These powerful AI image analysis models may not only be able to detect and/or classify patterns faster than human observers, the AI models may be more accurate and/or detect patterns not identified by human observers. Furthermore, multiple measurements (e.g., repair count and current) may be used to generate a multi-dimensional a heatmap that may be analyzed by an AI model, which may be difficult for a human to interpret.

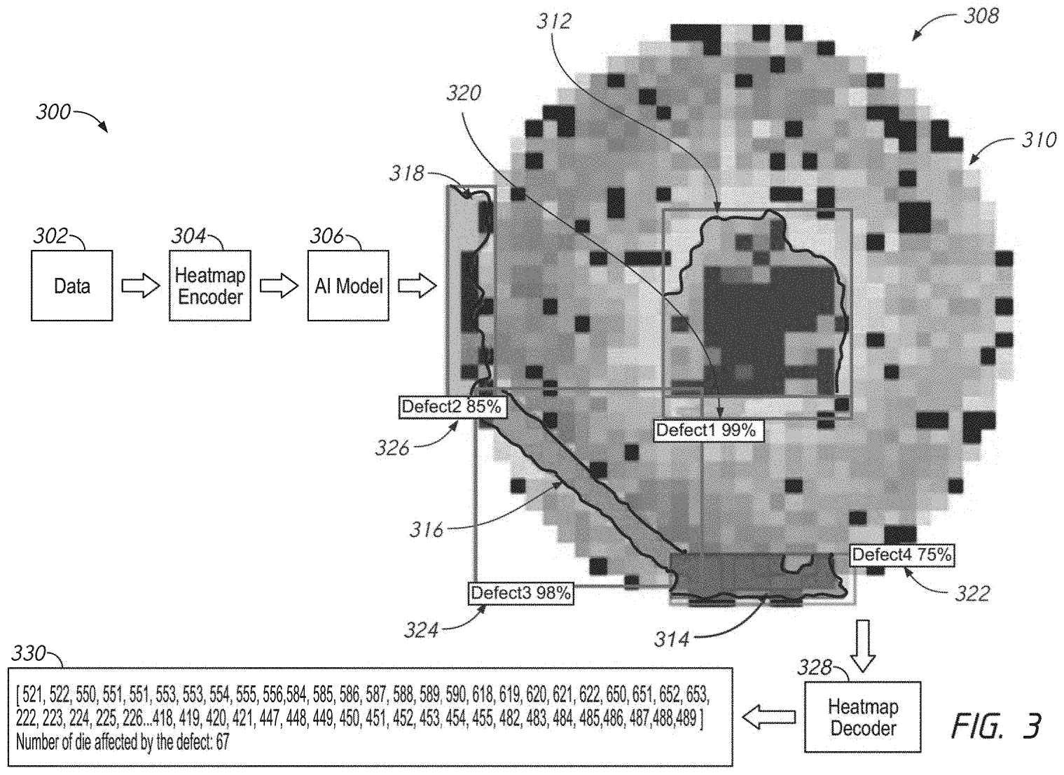

FIG. 3 is a diagram illustrating an overview of data flow according to at least one embodiment of the present disclosure. As indicated in diagram 300, data 302 may be provided to a heatmap encoder 304. In some embodiments, the data 302 may include multiple data points. In some embodiments, the data points may be measurement values (e.g., temperature, leakage current, voltage) acquired from one or more spatial locations (e.g., transistors in a circuit, die on a wafer). Information related to the spatial location of individual measurements may be included in the data 302 in some embodiments. The spatial location information may be provided as Cartesian coordinates, polar coordinates, and/or any other suitable coordinate system. The spatial location information may be one, two, and/or three dimensional. The heatmap encoder 304 may generate a heatmap based, at least in part, on the measurement values. The heatmap may include one or more pixels, where individual pixels may correspond to individual spatial locations in some embodiments. One or more properties of the pixels (e.g., intensity, hue), may be based, at least in part, on the measurement values to encode the data 302 into the heatmap. For example, in some embodiments, the heatmap encoder 304 may include a colormap (e.g., color map 102). The heatmap encoder 304 may compare the value of a data point to values included in the colormap and assign a pixel a color and/or intensity based on the color and/or intensity associated with the value in the colormap. In some embodiments, the heatmap encoder 304 may assign a location of the pixel within the heatmap based, at least in part, on the spatial location information associated with the data point.

The heatmap generated by the heatmap encoder 304 may be provided to an AI model 306. The AI model 306 may include one or more models trained to make an inference from the heatmap, such as identification (e.g., detection) and/or classification of patterns in the heatmap. In some embodiments, the AI model 306 may use semantic segmentation and/or instance segmentation to identify and/or classify patterns. Other segmentation techniques may be used in other examples. In some embodiments, the AI model may include one or more neural networks. In some embodiments, the AI model may include one or more convolutional neural networks, such as a region-based convolutional neural network (R-CNN). Examples of suitable AI models include, but are not limited to, Mask R-CNN, Faster R-CNN with a Region Proposal Network, DeepMask with Fast R-CNN, a fully convolutional instance segmentation (FCIS), or combinations thereof. The AI model 306 may provide an output 308 including the inference, such as identified patterns (if any) and/or classification of the patterns. In some embodiments, the output 308 may indicate the pixels included in the patterns within the heatmap. Optionally, in some embodiments, the output 308 may include confidence levels (e.g., scores) associated with the patterns and/or classification thereof.

The output 308 of the AI model 306 may be used to provide one or more graphical overlays that may be displayed on a heatmap that may provide graphical indications of the inferences. In the example shown in FIG. 3, graphical overlays including boundaries and text boxes are shown overlaid on a heatmap 310. The heatmap 310 may be generated by encoding data acquired from die on a semiconductor wafer by heatmap encoder 304. Boundaries 312, 314, 316, and 318 indicate the locations of patterns identified in heatmap 310. Text boxes 320, 322, 324, and 326 indicate the classifications of the corresponding patterns and confidence levels of the classifications. In the example shown in FIG. 3, the pattern indicated by boundary 312 is classified as one defect (Defect1) with a 99% confidence level; the pattern indicated by boundary 314 is classified as another defect (Defect4) with a 75% confidence level; the pattern indicated by boundary 316 is classified as yet another defect (Defect3) with a 98% confidence level; and the pattern indicated by boundary 318 is classified as another defect (Defect2) with an 85% confidence level.

In other embodiments, the output 308 may not be provided graphically. For example, the output 308 may include text indicating which patterns (if any) that were identified, corresponding classifications, and/or corresponding confidence levels. In some examples, the output 308 may textually indicate which pixels of the heatmap 310 are included with each pattern. For example, a Cartesian coordinate system for the heatmap 310 may be generated, and the coordinates for pixels of individual patterns may be provided. In some examples, both textual and graphical overlay information may be included with the output 308. The output 308 may be provided for display (e.g., a screen), storage in a non-transitory computer-readable medium, and/or to another AI model (not shown in FIG. 3) or application for further processing.

In some examples, the output 308 may be provided to a heatmap decoder 328. The heatmap decoder 328 may convert the pixels of the heatmap 310 to physical locations and output location information 330. The location information 330 may include physical locations of the patterns of the output 308 in some embodiments. For example, the location information 330 may indicate which die on a wafer are included in a pattern. Although the location information 330 is shown as text in the example of FIG. 3, the location information 330 may include graphical information and/or other information in other examples.

In some embodiments, the heatmap encoder 304, AI model 306, and/or heatmap decoder 328 may be implemented by a set of computer-readable instructions (e.g., software, software module, software application) that are executed by one or more processors. In some embodiments, the heatmap encoder 304, AI model 306, and/or heatmap decoder 328 may be implemented by hardware, such as application specific integrated circuits (ASICs) and/or field programmable gate arrays (FPGAs). In some embodiments, heatmap encoder 304, AI model 306, and/or heatmap decoder 328 may be implemented as a combination of hardware and software.

As noted, the AI model 306 may be trained to identify various patterns/defects in heatmaps. The AI model 306 may additionally be trained to classify the various patterns in the heatmaps. The types of patterns, classifications, and quantity thereof may vary based on application. In the example shown in FIG. 3, the AI model 306 is trained to identify and classify various defects in a semiconductor wafer. However, the AI model 306 may be trained to identify different patterns in the semiconductor wafer or patterns in different objects. For example, an AI model may be trained to detect patterns in heatmaps generated from data acquired from circuits (e.g., field programmable gate arrays) and the patterns may include shorts and/or poor connections.

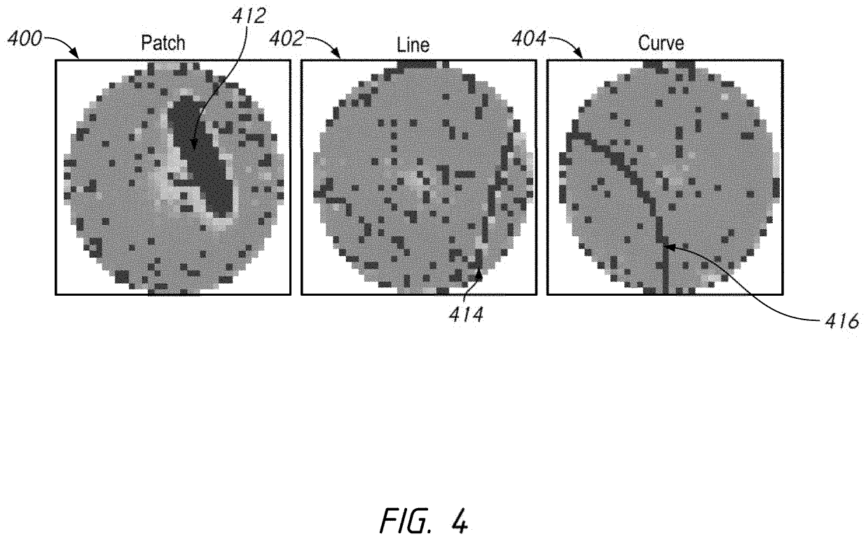

FIG. 4 shows example heatmaps of semiconductor wafers according to at least one embodiment of the present disclosure. The heatmaps 400, 402, and 404 illustrate different types of wafer defects that an AI model, such as AI model 306, may be trained to identify and/or classify. Heatmap 400 illustrates an example of a patch 412 defect on a wafer. Heatmap 402 was generated from data acquired from a wafer with a line 414 defect. Heatmap 404 illustrates an example of a wafer with a curve 416 defect. The defects shown and described in FIGS. 3 and 4 are provided merely as examples. In other embodiments, the AI model may be trained to identify more, fewer, and/or different defects in wafers based on heatmaps.

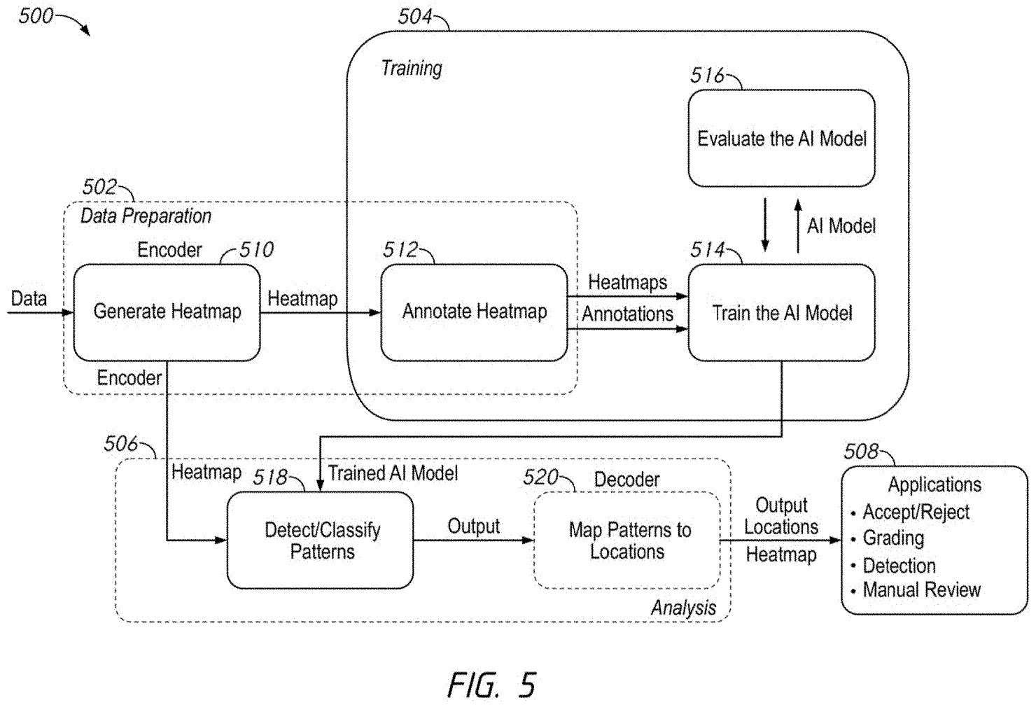

FIG. 5 is a flowchart providing an overview of methods according to at least one embodiment of the present disclosure. As shown in flowchart 500, data preparation 502, training 504, and/or analysis 506 may be performed. Data preparation 502 may be performed for training an AI model to analyze heatmaps as well as for preparing data for analysis by a trained AI model. Data, such as numerical data, may be encoded as a heatmap, such as heatmap 310, as indicated by block 510. In some embodiments, the heatmap may be generated from the data by an encoder, such as encoder 304.

The heatmap generated at block 510 may be provided for analysis 506 and/or training 504. When a heatmap is used for training, the heatmap may be annotated as indicated by block 512. The annotations indicate the desired and/or correct output of an AI model when the heatmap is provided as an input. Annotation may be performed manually and/or semi-automatically. For example, when annotation is performed manually, a user may indicate a location of a pattern on a heatmap and/or a classification of the pattern in the heatmap. In an example when annotation is performed semi-automatically, image segmentation techniques may be used on the heatmap (e.g., thresholding, watershed algorithms, gradient analysis) to find patterns. A user may then add classifications to the patterns. Other annotation techniques may be used in other embodiments.

The annotated heatmap (e.g., annotations and heatmap) may be included in a training data set. A training data set may include several, several hundred, or several thousand annotated heatmaps. The size of the training data set may be based, at least in part, on the complexity of the patterns and/or the number of different types of patterns to be identified and/or classified. The training data set may be used to train an AI model, such as AI model 306, as indicated by block 514. The training data set may be used to determine the architecture and/or other parameters of AI model. Parameters may include number of layers, values for weights of matrices and/or vectors. During training, acceptable parameters of the AI model are determined based, at least in part, on the accuracy of predictions/inferences (e.g., identification and/or classifications) made by the AI model with the parameters. In some embodiments, the accuracy may be determined based on a comparison of the output of the AI model and the annotations generated at block 512. The AI model may be considered trained when the outputs match, or are within an acceptable range of, the annotations. The acceptable range of the outputs (e.g., accuracy within 1%, within 5%, within 10% of the annotations) may be based on various factors such as available computational resources, computation time, and/or potential damage due to an undetected and/or misclassified pattern. For example, if the potential damage is low, the acceptable range may be greater. The parameters of the AI model that provide outputs with the acceptable accuracy may be used with the AI model when it is deployed (e.g., implemented) for analysis 506.

In some embodiments, the accuracy of predictions may be represented by a loss function. The value of the loss function may be high when the AI model makes poor predictions (e.g., inaccurately identifies and/or classifies a pattern in the heatmap) and may be lower when the AI model makes good predictions (e.g., more accurately identifies and/or classifies a pattern in the heatmap). The AI model may be considered trained when the loss function reaches a minimum value. The parameters of the AI model that provide the minimum value of the loss function may be used with the AI model when it is deployed for analysis.

In some embodiments, after training with the training data set at block 514, the trained AI model may be evaluated as indicated by block 516. In some embodiments, the trained AI model may analyze heatmaps not provided in the training data set without annotations, referred to as an evaluation data set. While annotations are not provided to the AI model, the evaluation data set may include annotations that are used to determine the accuracy of the AI model's outputs (e.g., how well the AI model was trained). If the AI model's outputs are within an acceptable margin of error of the annotations of the evaluation data set, the AI model may be deployed for analysis 506. If the AI model's outputs are outside the acceptable margin of error, the AI model may be retrained and/or continue training at block 514 with additional training data sets and evaluated again at block 516.

Once the AI model is trained, it may be deployed to analyze new, unannotated heatmaps to detect and/or classify patterns in the heatmaps as indicated by block 518. The AI model may provide an output, which may include patterns, classifications, locations of the patterns in the heatmap, and/or confidence levels for the identifications and/or classifications, similar to or the same as output 308. The output of the AI model may be used for applications 508.

The output of the AI model may be provided to a decoder, such as decoder 328, as indicated by block 520. The decoder may map the patterns identified by the AI model in the heatmap to physical locations where the data used to generate the heatmap were acquired (e.g., location of a transistor in a circuit, location of a die on a wafer). However, when the physical locations are not necessary for applications 508, this block 520 may be omitted.

The output of the trained AI model generated at block 518, the heatmap generated at block 510, and/or the locations generated at block 520, collectively output data, may be provided for one or more applications 508. The applications 508 may be implemented by hardware, software (e.g., computer executable instructions), human interaction, and/or combinations thereof. The applications 508 may be implemented, at least in part, by one or more AI models in some embodiments. Applications 508 may include, but are not limited to, making decisions, detection, tracking trends, and/or providing display information based, at least in part, on the output data.

In an example where the heatmap is generated of a semiconductor wafer including multiple die, the output data may be used to decide whether to accept or reject individual die and/or the entire wafer. For example, if a percentage of die included in defects is equal to or greater than a threshold value, the entire wafer may be rejected. When the percentage of die included in the defects is below the threshold value, only the individual die included in the defects maybe discarded. Continuing the semiconductor wafer example, the output data may be used to grade individual die. For example, those die determined by the AI model to be included in a defect may be graded as low quality, die in locations near or directly adjacent to the defect may be graded as moderate quality, and die in locations more distant from the defects may be graded as high quality. Again, for a semiconductor wafer example, output data related to defects (e.g., defect classification) may be analyzed alone or in combination with additional data (e.g., production line, batch number) to detect equipment malfunction. In some examples, output data may be collected over time to detect trends, such as most common types of defects, most common locations of defects, yields, and so forth. In some examples, the output data may be provided for manual review. For example, a display may provide the heatmap with one or more graphical overlays, such as those shown in the example of FIG. 3, for viewing by a user.

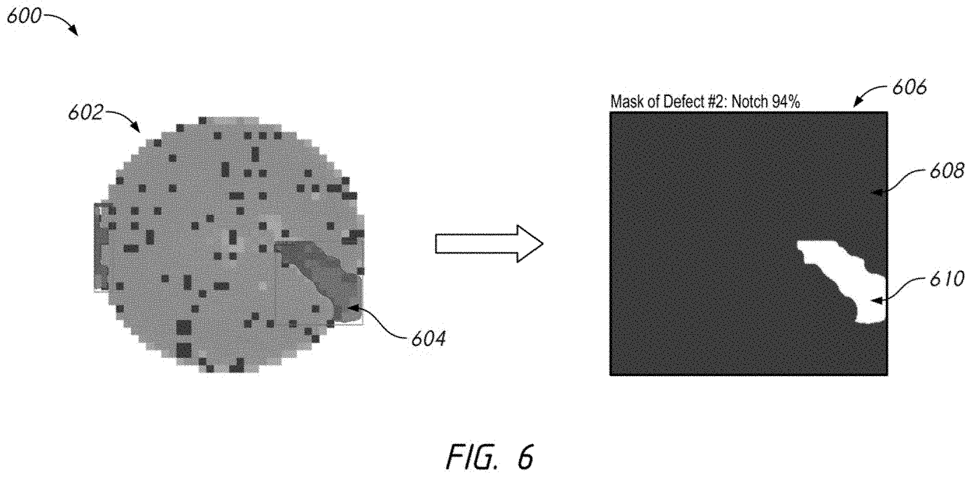

FIG. 6 is an illustration of an example application of output data according to at least one embodiment of the present disclosure. In the application 600, the output of an AI model, such as AI model 306, may include an identification and classification of a defect 604 on a heatmap 602. The heatmap 602 may correspond to a semiconductor wafer where individual pixels correspond to individual die. The output of the AI model (e.g., output 308) may be combined with location information (e.g., location information 330) for the die of the wafer to determine which die of the wafer are included in the defect 604. The output of the AI model and the location information may be used to generate a pixel mask 606. The pixel mask 606 may include a set of pixels 608 corresponding to die not included in the defect 604 and a set of pixels 610 corresponding to die included in the defect 604. In some embodiments, the pixel mask 606 may be used to calculate a yield for the wafer (e.g., accepted/rejected ratio). In some embodiments, the pixel mask 606 may be used to program equipment to sort die at locations corresponding to pixels 610 differently than die at locations corresponding to pixels 608 when the die are removed from the wafer (e.g., placed in different containers, placed in different fabrication lines). The example shown in FIG. 6 is merely one application for using the output of an AI model, and as discussed with reference to FIG. 5, other or additional applications may be performed based on the output of the AI model.

As noted in FIG. 5, training data sets may include many (e.g., hundreds or thousands) of annotated entries. Often times, annotating is performed manually and can require significant time by expert reviewers. Typically, AI models for image analysis must be retrained to identify and/or classify patterns in different contexts. For example, an AI model trained to recognize patterns in computed tomography images for medical diagnosis cannot be reused to recognize patterns in optical images for guiding autonomous vehicles. While the same underlying architecture may be used (e.g., UNet, Mask R-CNN), the number of layers, various weights and coefficients, or other parameters of the AI model may need to be modified for proper pattern recognition. Thus, new training data sets may need to be prepared and provided to retrain the AI model.

In contrast, when non-imaging/numerical data (e.g., current, temperature) are encoded as a heatmap, in some applications, a trained AI model may be “reused” across multiple data sets. For example, an AI model trained to identify and/or classify patterns in heatmaps generated from leakage current data from die on a semiconductor wafer may be able to accurately identify and/or classify patterns in heatmaps generated from impedance data from die on a semiconductor wafer with little to no retraining. In some applications, the AI model may need little to no retraining when similar patterns and/or classifications are to be determined by the AI model. In some applications, the AI model may need little to no retraining when a same color map (e.g., range of colors and intensities of pixels) is used to generate the heatmap between data types. Reducing or eliminating retraining of the AI model may reduce time and/or costs associated with the AI model and/or increase applications for which the AI model can be used.

While traditional imaging data may be multi-dimensional, these dimensions are typically limited to space (e.g., two-dimensional and three-dimensional) and time. Additionally, multi-channel imaging data is typically limited hues (e.g., red, green, and blue channels). However, according to embodiments of the present disclosure, AI models may be trained to analyze multi-dimensional and/or multi-channel datasets where one or more dimensions and/or channels correspond to different data ranges, data sets and/or types of data. This may improve accuracy of predictions by AI models and/or allow identification and/or classification of a wider range of patterns and/or more complex patterns in some applications. Without being bound to a particular theory, in some cases, these potential improvements may be due, at least in part, to different patterns being more prominent in different ranges of a data set or different data types. In some cases, these potential improvements may be due, at least in part, to different data types having at least some correlation (e.g., higher current may be associated with higher temperatures). Thus, the cumulative information of the different data types may provide greater predictive information than the data types analyzed separately in some applications.

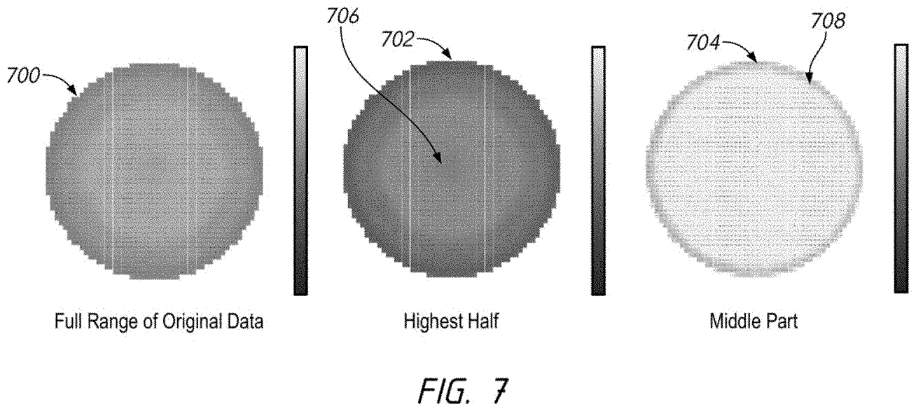

FIG. 7 is an example of multiple heatmaps generated from a same data set according to at least one embodiment of the disclosure. The heatmaps 700, 702, and 704 may have been generated from a same set of data. For example, temperature readings for a set of physical locations. However, the individual heatmaps 700, 702, and 704 are generated from different ranges of the data. Heatmap 700 was generated from the full range of the data set (e.g., all values). Heatmaps 702 and 704 were generated from half of the data set. The half used to generate heatmap 702 included the highest values of the data set (e.g., half of data set with lowest values excluded). The half used to generate heatmap 704 included the middle values (e.g., a quarter of the highest values and a quarter of the lowest values were excluded).

In the example shown in FIG. 7, heatmap 702 provides better detectability of a pattern 706 in the center of the heatmap 702 compared to heatmaps 700 and 704. In contrast, heatmap 704 provides better isolation of a pattern 708 on an edge of the heatmap 704 compared to heatmaps 700 and 702. Thus, different patterns may be easier to detect in the different heat maps 700, 702, 704. In some applications, an AI model analyzing all three heatmaps 700, 702, 704 may provide a more accurate identification and/or classification of patterns than if the AI model only analyzed one of the heatmaps 700, 702, 704.

Although three heatmaps based on three different ranges of the data set are shown in FIG. 7, in other examples, two ranges may be used to generate two different heatmaps from the data set. In other examples, more than three ranges may be used to generate more than three different heatmaps from the data set.

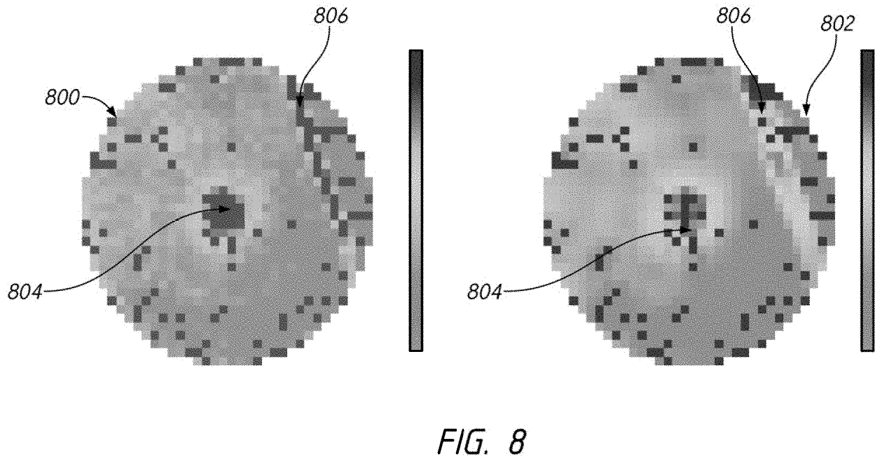

FIG. 8 is an example of multiple heatmaps generated from different data sets for same physical locations according to at least one embodiment of the disclosure. The heatmaps 800 and 802 may have been generated from two different data sets. However, the individual values of the two different data sets may correspond to a same set of physical locations. For example, heatmap 800 may have been generated based on repair data for die on a semiconductor wafer and heatmap 802 may have been generated based on impedance data for the die on the semiconductor wafer.

In the example shown in FIG. 8, heatmap 800 may provide better detectability of ellipsoid defect 804 than heatmap 802, whereas heatmap 802 may provide better detectability of scratch defect 806 than heatmap 800. Accordingly, in some applications, an AI model analyzing both heatmaps 800 and 802 may provide a more accurate identification and/or classification of patterns than if the AI model only analyzed one of heatmaps 800, 802.

Although two heatmaps based on two different data types are shown in FIG. 8, in other examples, more than two data types may be used to generate more than two heatmaps.

Multi-channel and/or multi-dimensional data may be analyzed by AI models by one or more techniques. In some embodiments, channels and/or dimensions may be analyzed by individual AI models. The outputs of the individual AI models may be provided separately and/or combined to provide a combined output. In some applications, analyzing the dimensions and/or channels by different AI models may be faster. For example, in some applications, it may be easier to parallelize processing when different AI models analyze different channels and/or dimensions. In some applications, analyzing the dimensions and/or channels by different AI models may allow AI models to be trained to identify and/or classify patterns specific to those channels and/or dimensions.

In some embodiments, channels and/or dimensions may be analyzed by an AI model. In some embodiments, the inferences made by the AI model may be influenced by multiple channels and/or dimensions. In some embodiments, information from multiple channels and/or dimensions may be accumulated by the AI model to provide the inference. In some applications, analyzing all of the channels and/or dimensions by the AI model may allow the AI model to take advantage of relationships between data in the different channels and/or dimensions to identify and/or classify patterns.

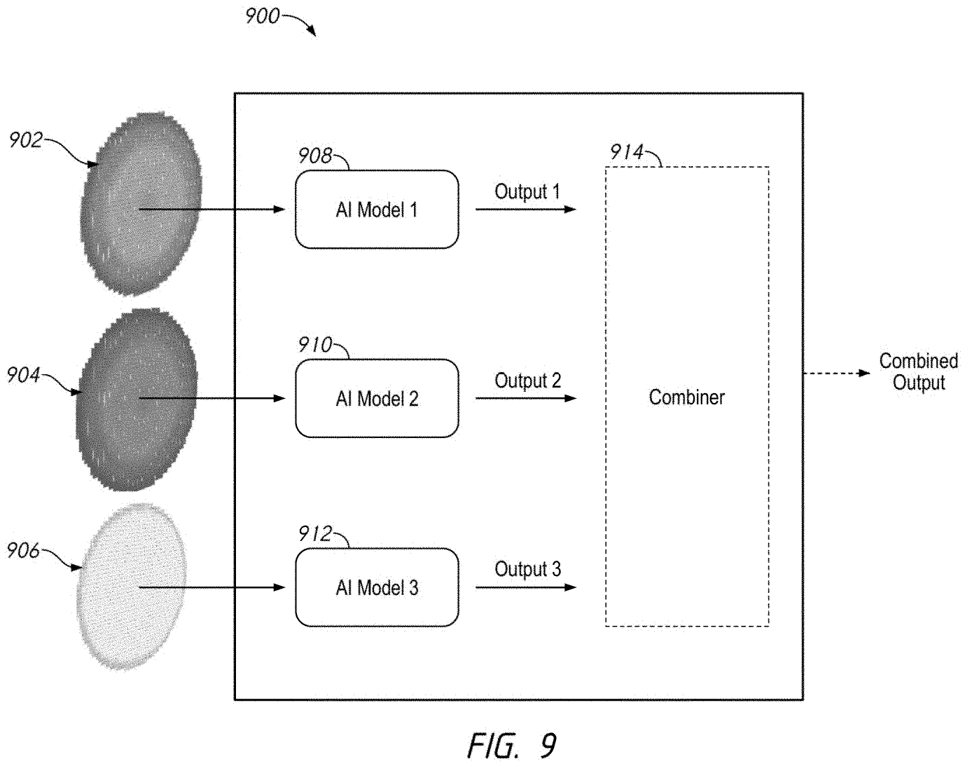

FIG. 9 is a block diagram of a model for analyzing data according to at least one embodiment of the disclosure. The model 900 may receive multiple heatmaps 902, 904, 906 as inputs. Although three heatmaps are shown in FIG. 9, any number of heatmaps may be provided as inputs. In some embodiments, the heatmaps 902, 904, 906 may have been generated from different ranges of a same data set, for example, as described with reference to FIG. 7. In some embodiments, heatmaps 902, 904, 906 may have been generated from different data types, for example, as described with reference to FIG. 8. Other relationships may exist between heatmaps 902, 904, 906 in other embodiments (e.g., heatmaps 902, 904, 906 generated from data acquired at different times).

The model 900 may include multiple AI models 908, 910, and 912. In some embodiments, the AI models 908, 910, and 912 may correspond to AI model 306. The number of AI models included model 900 may correspond to a number of heatmaps provided as inputs to the model 900, which is three in the example shown in FIG. 9. The AI models 908, 910, and 912 may receive heatmap 902, 904, and 906, respectively. The AI models 908, 910, and 912 may analyze the corresponding heatmap 902, 904, and 906 and provide a corresponding output which may include information such as any identified and/or classified patterns. In some embodiments, the outputs of the AI models 908, 910, and 912 may correspond to output 308.

In some embodiments, the separate outputs of AI models 908, 910, and 912 may be the output of the model 900. In other embodiments, two or more of the separate outputs may be combined by a combiner 914 to provide a single combined output from the model 900. In some embodiments, the combiner 914 may perform one or more operations on the outputs of the AI models 908, 910, and 912 to generate the combined output. Example operations include, but are not limited to, a sum, a weighted sum, an average, a weighted average, and/or a combination thereof. The combiner 914 may be implemented in software (e.g., executable instructions) and/or hardware. In some embodiments, the combined output may be used for various applications, such as applications 508.

In some embodiments, the AI models 908, 910, and 912 may have the same architecture (e.g., all may be Mask R-CNN models). In some embodiments, at least one of the AI models 908, 910, and 912 may have a different architecture from the other AI models. In some embodiments, the AI models 908, 910, and 912 may be trained separately. In other embodiments, a single AI model may be trained and replicated to provide AI models 908, 910, and 912.

In some applications, model 900 may permit independent analysis of the heatmaps 902, 904, 906. In some applications, model 900 make parallel processing of the heatmaps 902, 904, 906 easier, which may reduce processing time.

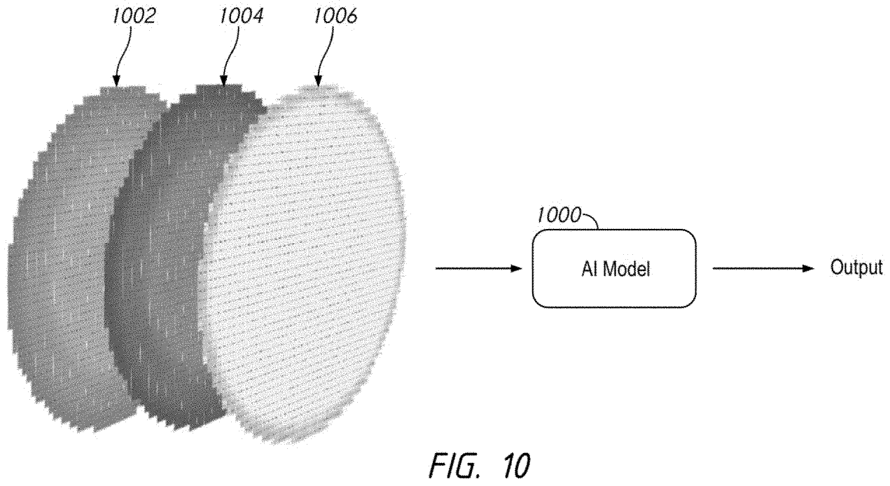

FIG. 10 is a block diagram of a model for analyzing data according to at least one embodiment of the disclosure. The model 1000 may receive a multi-channel and/or multi-dimensional input. In some embodiments, a heatmap may be provided for an individual channel and/or dimension. In the example shown in FIG. 10, heatmaps 1002, 1004, 1006 as channels of a multi-channel and/or multi-dimensional input. Although three heatmaps are shown in FIG. 10, any number of heatmaps may be provided. The number of heatmaps provided may correspond to the number of channels and/or dimensions. In some embodiments, the heatmaps 1002, 1004, 1006 may have been generated from different ranges of a same data set, for example, as described with reference to FIG. 7. In some embodiments, heatmaps 1002, 1004, 1006 may have been generated from different data types, for example, as described with reference to FIG. 8. Other relationships may exist between heatmaps 1002, 1004, 1006 in other embodiments (e.g., heatmaps 1002, 1004, 1006 generated from data acquired at different times).

The model 1000 may include an AI model, such as AI model 306. The model 1000 may analyze the heatmaps 1002, 1004, and 1006 and provide an output which may include information such as any identified and/or classified patterns. In some embodiments, the output of the AI model 1000 may correspond to output 308. In some embodiments, the model 1000 may allow information from the heatmaps 1002, 1004, and 1006 to be accumulated to make an inference/prediction. In some applications, this may improve the accuracy of the identification and/or classifications. In some applications, this may allow the model 1000 to identify and/or classify additional patterns.

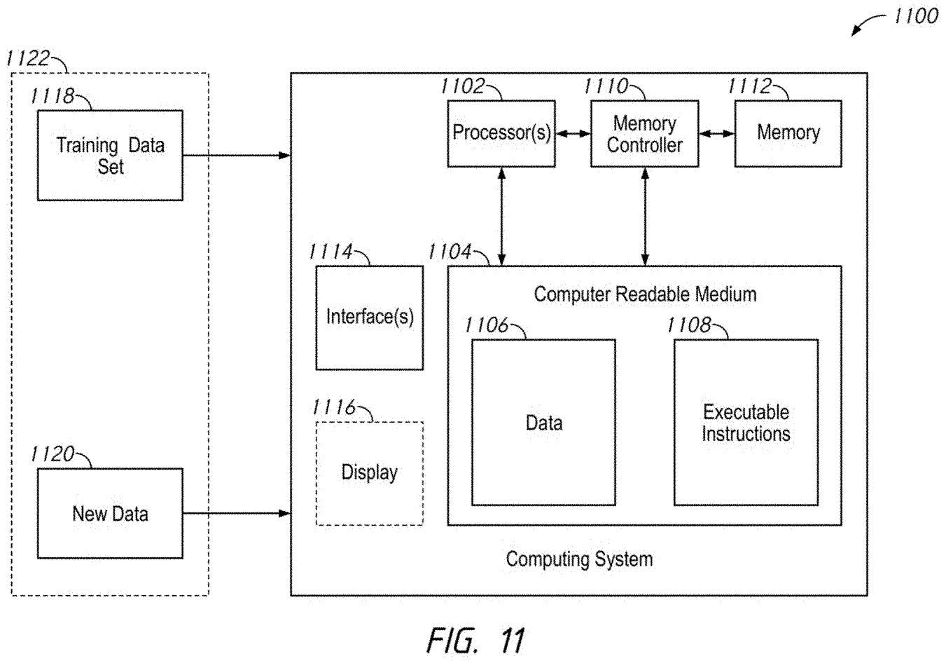

FIG. 11 is a schematic illustration of a computing system arranged according to at least one embodiment of the present disclosure. The computing system 1100 may be used to implement one or more models, such as A 1 model 306, model 900, AI model 908, AI model 910, AI model 912, and/or model 1000. The computing system 1100 may be used to implement one or more components, such as encoder 304, decoder 328, and/or combiner 914, and/or applications, such as the applications described with reference to block 508 and/or FIG. 6. The computing system 1100 may include a processor (or processors) 1102, a computer readable medium (or media) 1104, a memory controller 1110, a memory 1112, and an interface (or interfaces) 1114. In some examples, the computing system 1100 may include a display 1116.

The computer readable medium 1104 may be accessible to the processor 1102. The computer readable medium 1104 may be encoded with executable instructions 1108. The executable instructions 1108 may include executable instructions for generating one or more heatmaps from data (e.g., numerical data, non-imaging data). The executable instructions 1108 may include executable instructions for implementing one or more models, which may include one or more AI models, to identify and/or classify patterns in the heatmaps. The executable instructions 1108 may be executed by the processor 1102. In some examples, the executable instructions 1108 may also include instructions for generating or processing training data sets and/or training the one or more models. Alternatively or additionally, in some examples, one or more of the models, or a portion thereof, may be implemented in hardware included with the computer readable medium 1104 and/or processor 1102, for example, application-specific integrated circuits (ASICs) and/or field programmable gate arrays (FPGA).

The computer readable medium 1104 may store data 1106. In some examples, the data 1106 may include one or more training data sets, such as training data set 1118. The training data set 1118 may include one or more annotated heatmaps. In some examples, training data set 1118 may be received from another computing system (e.g., a cloud computing system, a testing system). In other examples, the training data set 1118 may be generated by the computing system 1100. In some examples, the training data sets may be used to train one or more AI models. In some examples, the data 1106 may include data used in an AI model (e.g., weights, connections between nodes). In some examples, the data 1106 may include other data, such as new data 1120. The new data 1120 may include one or more heatmaps not included in the training data set 1118. In some examples, the new data 1120 may be analyzed by a trained AI model to provide an output, which may include identification and/or classification of patterns in the heatmap. In some examples, the data 1106 may include outputs (e.g., pixel mask, graphical overlays) generated based on the output of the one or more models by one or more applications implemented by the computing system 1100. The computer readable medium 1104 may be implemented using any medium, including non-transitory computer readable media. Examples include memory, random access memory (RAM), read only memory (ROM), volatile or non-volatile memory, hard drive, solid state drives, or other storage. While a single medium is shown in FIG. 11, multiple media may be used to implement computer readable medium 1104.

In some examples, the processor 1102 may be implemented using one or more central processing units (CPUs), graphical processing units (GPUs), ASICs, FPGAs, or other processor circuitry. In some examples, the processor 1102 may execute some or all of the executable instructions 1108. In some examples, the processor 1102 may be in communication with a memory 1112 via a memory controller 1110. In some examples, the memory 1112 may be volatile memory, such as dynamic random access memory (DRAM). The memory 1112 may provide information to and/or receive information from the processor 1102 and/or computer readable medium 1104 via the memory controller 1110 in some examples. While a single memory 1112 and a single memory controller 1110 are shown, any number may be used. In some examples, the memory controller 1110 may be integrated with the processor 1102.

In some examples, the interface 1114 may provide a communication interface to another device (e.g., testing system, testing probe), a user, and/or a network (e.g., LAN, WAN, Internet). The interface 1114 may be implemented using a wired and/or wireless interface (e.g., Wi-Fi, BlueTooth, HDMI, USB, etc.). In some examples, the interface 1114 may include user interface components which may receive inputs from a user. Examples of user interface components include a keyboard, a mouse, a touch pad, a touch screen, and a microphone. In some examples, the interface 1114 may communicate information, which may include user inputs, data 1106, training data set 1118, and/or new data 1120, between external devices and one or more components of the computing system 1100 (e.g., processor 1102 and computer readable medium 1104).

In some examples, the computing system 1100 may be in communication with a display 1116 that is a separate component. (e.g., using a wired and/or wireless connection) or the display 1116 may be integrated with the computing system. In some examples, the display 1116 may display data 1106 such as outputs (e.g., outputs 308) generated by one or more models implemented by the computing system 1100. Any number or variety of displays may be present, including one or more LED, LCD, plasma, or other display devices.

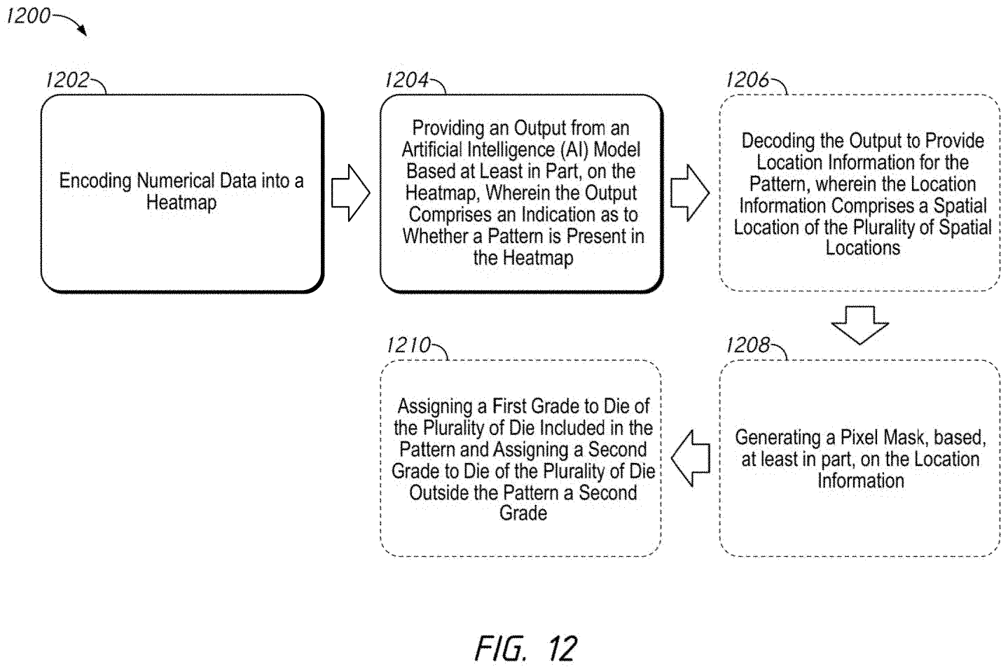

FIG. 12 is a flow chart of a method according to at least one embodiment of the present disclosure, in some embodiments, the method 1200 may be performed in whole or in part by AI model 306, model 900, AI model 908, AI model 910, AI model 912, model 1000, and/or computing system 1100.

At block 1202, “encoding numerical data into a heatmap” may be performed. In some embodiments, the numerical data may include a plurality of data points corresponding to a plurality of spatial locations and the heatmap may include a plurality of pixels, wherein the plurality of pixels correspond to the plurality of data points. In some embodiments, a property of a pixel of the plurality of pixels may be based, at least in part, on a value of a corresponding data point of the plurality of data points. In some embodiments, the numerical data into the heatmap comprises assigning colors to the plurality of pixels based on values of corresponding ones of the plurality of data points, based, at least in part, on a colormap. For example, as described with reference to FIG. 1. In some embodiments, the colormap assigns colors to an entire range of the values of the plurality of data points. In some embodiments, the colormap assigns a same color to values of the plurality of data points equal to or below a threshold value. In some embodiments, the colormap assigns a same color to values of the plurality of data points equal to or above a threshold value.

At block 1204, “providing an output from an artificial intelligence (AI) model based at least in part, on the heatmap, wherein the output comprises an indication as to whether a pattern is present in the heatmap” may be performed.

In some embodiments, at block 1206, “decoding the output to provide location information for the pattern, wherein the location information comprises a spatial location of the plurality of spatial locations” may be performed. For example, as described with reference to FIGS. 3 and 5. In some embodiments, when block 1206 is performed, at block 1208, “generating a pixel mask, based, at least in part, on the location information” may be performed. The pixel mask may be generated as described in FIG. 6 in some embodiments.

In some embodiments, the plurality of spatial locations correspond to a plurality of die on a semiconductor wafer, and the method 1200 may further include “assigning a first grade to die of the plurality of die included in the pattern and assigning a second grade to die of the plurality of die outside the pattern a second grade” at block 1210. In some embodiments, the first grade and the second grade are different. In some embodiments, more than two different grades may be assigned. In some embodiments, additional measurements and/or other data may also be used to assign the grades to the die. Although shown after blocks 1206 and 1208, in some embodiments, block 1210 may be performed before, concurrently, and/or instead of block 1206 and/or 1208.

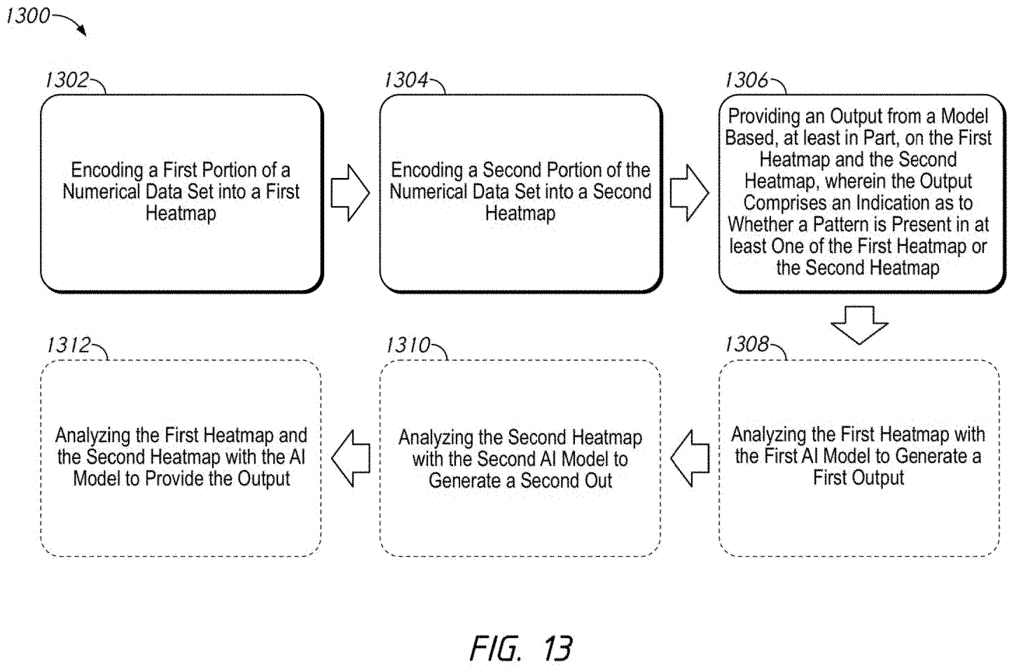

FIG. 13 is a flow chart of a method according to at least one embodiment of the present disclosure. In some embodiments, the method 1300 may be performed in whole or in pan by AI model 306, model 900, AI model 908, AI model 910, AI model 912, model 1000, and/or computing system 1100.

At block 1302, “encoding a first portion of a numerical data set into a first heatmap” may be performed. In some embodiments, the numerical data set includes a plurality of data points corresponding to a plurality of spatial locations, and the first heatmap includes a first plurality of pixels corresponding to a plurality of data points of the first portion. At block 1304, “encoding a second portion of the numerical data set into a second heatmap” may be performed. In some embodiments, the second heatmap may include a second plurality of pixels corresponding to a plurality of data points of the second portion. In some embodiments, the first and second portions of the data set may correspond to data points with different ranges of values, as described with reference to FIG. 7. In some embodiments, the first and second portions of the data set may correspond to different data types (e.g., voltage, impedance, temperature) as described with reference to FIG. 8. In some embodiments, the first and second portions may correspond to a same set of spatial locations.

At block 1306, “providing an output from a model based, at least in part, on the first heatmap and the second heatmap, wherein the output comprises an indication as to whether a pattern is present in at least one of the first heatmap or the second heatmap” may be performed.

In some embodiments, the model includes a first artificial intelligence (AI) model and a second AI model. In these embodiments, the method 1300 may further include “analyzing the first heatmap with the first AI model to generate a first output” at block 1308 and “analyzing the second heatmap with the second AI model to generate a second output” at block 1310. In some embodiments, the output includes the first output and the second output. In some embodiments, combining the first output and the second output may be performed to provide the output.

In some embodiments, method 1300 may further include training the first AI model with a first training data set and training the second AI model with a second training data set. In some embodiments, the second training data set is different from the first training data set. In other embodiments, method 1300 may further include training an AI model with a training data set and replicating the AI model to provide the first AI model and the second AI model.

Alternatively, instead of performing blocks 1308 and 1310, the model may include an artificial intelligence model and “analyzing the first heatmap and the second heatmap with the AI model to provide the output” may be performed at block 1312.

The systems, methods, and apparatus disclosed herein may allow “non-image” data (e.g., repair data, current measurements) to be organized as an image, such as a heatmap. Generating the heatmap may allow the data to be analyzed by one or more AI models designed for analyzing image data. The heatmap and/or AI models may allow additional information may be derived from the data in some applications. For example, patterns and/or additional information that may not have been as apparent or detectable when the data is in its original form. In some applications, use of heatmaps may allow “reuse” of AI models on multiple data types, which may reduce the amount of training required of AI models. In some applications, use of heatmaps may allow multiple data ranges and/or data types to be analyzed as different channels and/or dimensions of the data.

Although the examples described herein typically refer to semiconductor devices, including semiconductor wafers including die, and/or circuits, the systems, methods, and apparatuses disclosed are not limited to these applications. Rather, the techniques disclosed herein may be applied to any numerical data where individual data points are associated with spatial locations, either in one, two, or three dimensions.

Certain details are set forth herein provide a sufficient understanding of examples of various embodiments of the disclosure. However, it is appreciated that examples described herein may be practiced without these particular details. Moreover, the particular examples of the present disclosure described herein should not be construed to limit the scope of the disclosure to these particular examples. In other instances, well-known circuits, control signals, timing protocols, artificial intelligence models, and software operations have not been shown in detail in order to avoid unnecessarily obscuring embodiments of the disclosure. Additionally, terms such as “couples” and “coupled” mean that two components may be directly or indirectly electrically coupled. Indirectly coupled may imply that two components are coupled through one or more intermediate components.

What is claimed is:

1. A system comprising:
at least one processor; and
at least one non-transitory medium accessible to the processor encoded with instructions that, when executed, cause the system to:
encode a numerical data set into a heatmap, wherein individual data points of the numerical data set correspond to respective spatial locations and individual pixels of the heatmap correspond to the individual data points; and
implement an artificial intelligence (AI) model configured to provide an output comprising an indication as to whether a pattern is present in the heatmap.

2. The system of claim 1, wherein the AI model comprises a region-based convolutional neural network.

3. The system of claim 1, wherein the output further comprises an indication of a subset of pixels of the pixels of the heatmap that are included in the pattern, and wherein the instructions, when executed, further cause the system to decode the output to provide a spatial location of the pattern.

4. The system of claim 3, wherein the instructions, when executed, further cause the system to generate a pixel mask based on the spatial location of the pattern.

5. The system of claim 1, further comprising a display, wherein the instructions, when executed, further cause the system to generate display information for at least one of the heatmap or the output and provide the display information to the display.

6. The system of claim 5, wherein the display is configured to provide the output as graphical overlays on the heatmap.

7. The system of claim 1, wherein the output further comprises a classification of the pattern.

8. The system of claim 7, wherein the output further comprises a confidence level of the classification.

9. The system of claim 1, wherein the output further comprises a confidence level of the pattern.

10. The system of claim 1, wherein the spatial locations correspond to individual die on a semiconductor wafer.

11. The system of claim 10, wherein the pattern comprises a defect in the semiconductor wafer.

12. A method comprising:
encoding numerical data into a heatmap, wherein the numerical data comprises a plurality of data points corresponding to a plurality of spatial locations, wherein the heatmap comprises a plurality of pixels, wherein the plurality of pixels correspond to the plurality of data points; and
providing an output from an artificial intelligence (AI) model based at least in part, on the heatmap, wherein the output comprises an indication as to whether a pattern is present in the heatmap.

13. The method of claim 12, wherein a property of a pixel of the plurality of pixels is based, at least in part, on a value of a corresponding data point of the plurality of data points.

14. The method of claim 12, wherein encoding the numerical data into the heatmap comprises assigning colors to the plurality of pixels based on values of corresponding ones of the plurality of data points, based, at least in part, on a colormap.

15. The method of claim 14, wherein the colormap assigns colors to an entire range of the values of the plurality of data points.

16. The method of claim 14, wherein the colormap assigns a same color to values of the plurality of data points based on a comparison to a threshold value.

17. The method of claim 16, wherein the colormap assigns the same color to the values of the plurality of data points when the values are equal to or above the threshold value or when the values are equal to or below the threshold value.

18. The method of claim 12, further comprising decoding the output to provide location information for the pattern, wherein the location information comprises a spatial location of the plurality of spatial locations.

19. The method of claim 18, further comprising generating a pixel mask, based, at least in part, on the location information.

20. The method of claim 12, wherein the plurality of spatial locations correspond to a plurality of die on a semiconductor wafer, and the method further comprises assigning a first grade to die of the plurality of die included in the pattern and assigning a second grade to die of the plurality of die outside the pattern, wherein the first grade and the second grade are different.

21. A system comprising:
at least one processor; and
at least one non-transitory medium accessible to the processor encoded with instructions that, when executed, cause the system to:
encode a first portion of a numerical data set into a first heatmap, wherein the numerical data set comprises a plurality of data points corresponding to a plurality of spatial locations, and wherein the first heatmap comprises a first plurality of pixels, wherein the first plurality of pixels correspond to a plurality of data points of the first portion;
encode a second portion of the numerical data set into a second heatmap, wherein the second heatmap comprises a second plurality of pixels, wherein the second plurality of pixels correspond to a plurality of data points of the second portion; and
implement a model configured to provide an output comprising an indication as to whether a pattern is present in at least one of the first heatmap or the second heatmap.

22. The system of claim 21, wherein the first portion comprises a portion of the plurality of data points corresponding to a first range of values and the second portion comprises a portion of the plurality of data points corresponding to a second range of values, wherein the first range and the second range are different.

23. The system of claim 21, wherein the first portion comprises a first data type and the second portion comprises a second data type, wherein the first data type and the second data type are different.

24. The system of claim 21, wherein the plurality of spatial locations for the plurality of data points of the first portion are the same as the plurality of spatial locations for the plurality of data points of the second portion.

25. The system of claim 21, wherein the model comprises a first artificial intelligence (AI) model and a second AI model, wherein the first AI model analyzes the first heatmap and provides a first output and the second AI model analyzes the second heatmap and provides a second output.

26. The system of claim 25, wherein the output comprises the first output and the second output.

27. The system of claim 25, wherein the first output and the second output are combined to provide the output.

28. The system of claim 25, wherein the first AI model and the second AI model comprise at least one of a different architecture or a different parameter.

29. The system of claim 21, wherein the model comprises an artificial intelligence (AI) model configured to analyze the first heatmap and the second heatmap to provide the output.

30. The system of claim 21, wherein the numerical data set comprises data acquired from a plurality of die of a semiconductor wafer.

31. A method comprising:
encoding a first portion of a numerical data set into a first heatmap, wherein the numerical data set comprises a plurality of data points corresponding to a plurality of spatial locations and wherein the first heatmap comprises a first plurality of pixels corresponding to a plurality of data points of the first portion;
encoding a second portion of the numerical data set into a second heatmap, wherein the second heatmap comprises a second plurality of pixels corresponding to a plurality of data points of the second portion; and
providing an output from a model based, at least in part, on the first heatmap and the second heatmap, wherein the output comprises an indication as to whether a pattern is present in at least one of the first heatmap or the second heatmap.

32. The method of claim 31, wherein the model comprises a first artificial intelligence (AI) model and a second AI model, wherein the method further comprises:
analyzing the first heatmap with the first AI model to generate a first output; and
analyzing the second heatmap with the second AI model to generate a second output, wherein the output comprises the first output and the second output.

33. The method of claim 32, further comprising combining the first output and the second output to provide the output.

34. The method of claim 32, further comprising:
training the first AI model with a first training data set; and
training the second AI model with a second training data set, wherein the second training data set is different from the first training data set.

35. The method of claim 32, further comprising:
training an AI model with a training data set; and
replicating the AI model to provide the first AI model and the second AI model.

36. The method of claim 31, wherein the model comprises an artificial intelligence (AI) model and the method further comprises analyzing the first heatmap and the second heatmap with the AI model to provide the output.
